(19) United States
(12) Patent Application Publication
(10) Pub. No.: US 2014/0152035 A1
(43) Pub. Date: Jun. 5, 2014

(54) DROPPED FLOOR PUBLIC INTERFACE TRANSACTION AREA FOR RETAIL VEHICLES

(71) Applicant: SPARTAN MOTORS, INC., Charlotte, MI (US)

(72) Inventors: Douglas Allen WEINGART, Bristol, IN (US); Janet Catherine FOX, Granger, IN (US); Benjamin Amos KAUFFMAN, Elkhart, IN (US); Amanda Lynn LUNSTRUM, Elkhart, IN (US)

(73) Assignee: SPARTAN MOTORS, INC., Charlotte, MI (US)

(21) Appl. No.: 14/094,141

(22) Filed: Dec. 2, 2013

Related U.S. Application Data
(60) Provisional application No. 61/733,389, filed on Dec. 4, 2012.

(51) Int. Cl. B62D 25/20

(52) U.S. Cl. CPC B62D 25/20
USPC 296/25

(57) ABSTRACT

An enclosure for a vehicle includes a wall that has an opening therein, a floor, and a lowered portion that is recessed into the floor in an area of the floor proximate the opening in the wall.

### CROSS-REFERENCE TO RELATED APPLICATIONS

The present application claims the benefit of U.S. Provisional Patent Application No. 61/733,389, filed Dec. 4, 2012, which is hereby incorporated by reference in its entirety.

### BACKGROUND

The present disclosure relates generally to the field of mobile food facilities or other mobile retail facilities built on a vehicle frame.

Current retail vehicles/trailers, (e.g., mobile kitchens, mobile food service vehicles, etc.) may be built on a chassis and are configured such that the clerk or other person inside the vehicles/trailer (e.g., enclosure) is standing at standard truck floor heights, often a minimum of 32″ above ground. Meanwhile, a person outside the vehicle/trailer, who may interact with the person inside the vehicle/trailer, is generally standing at ground height. This height disparity can result in an uncomfortable experience for both parties and can represent a hazard if objects, such as hot food or liquids, are being passed from the person in the vehicle/trailer to the person outside.

### SUMMARY

One embodiment relates to an enclosure for a vehicle including a wall that has an opening therein, a floor, and a lowered portion that is recessed into the floor in an area of the floor proximate the opening in the wall.

### BRIEF DESCRIPTION OF THE DRAWINGS

Features, aspects, and advantages of embodiments of the present invention will become apparent from the following description and the accompanying exemplary embodiments shown in the drawings, which are briefly described below.

FIG. 1 is a passenger side perspective view of a retail vehicle/trailer with a dropped floor area, in accordance with an exemplary embodiment, shown with the roof and driver side wall removed.

FIG. 2 is a driver side perspective view of the retail vehicle/trailer of FIG. 1, shown with the roof and driver side wall removed.

FIG. 3 is a cross-section view of the retail vehicle/trailer of FIG. 1, taken along line 3-3.

FIG. 4 is a top plan view of the retail vehicle/trailer of FIG. 1.

FIG. 5 is a driver side plan view of the interior of the retail vehicle/trailer of FIG. 1.

FIG. 6 is a passenger side perspective view of a retail vehicle/trailer with a dropped floor area, in accordance with another exemplary embodiment, in which a portion of a wall in which an opening is provided is movable in a telescopic manner, shown with the roof and driver's side wall removed.

FIG. 7 is a driver side perspective view of the retail vehicle/trailer of FIG. 6, shown with the roof and driver's side wall removed.

FIG. 8 is a cross-section view of the retail vehicle/trailer of FIG. 6, taken along line 8-8.

FIG. 9 is a top plan view of the retail vehicle/trailer of FIG. 6.

FIG. 10 is a driver side plan view of the interior of the retail vehicle/trailer of FIG. 6.

### DETAILED DESCRIPTION

It is to be understood that the following detailed description is exemplary and explanatory only, and is not restrictive of the invention.

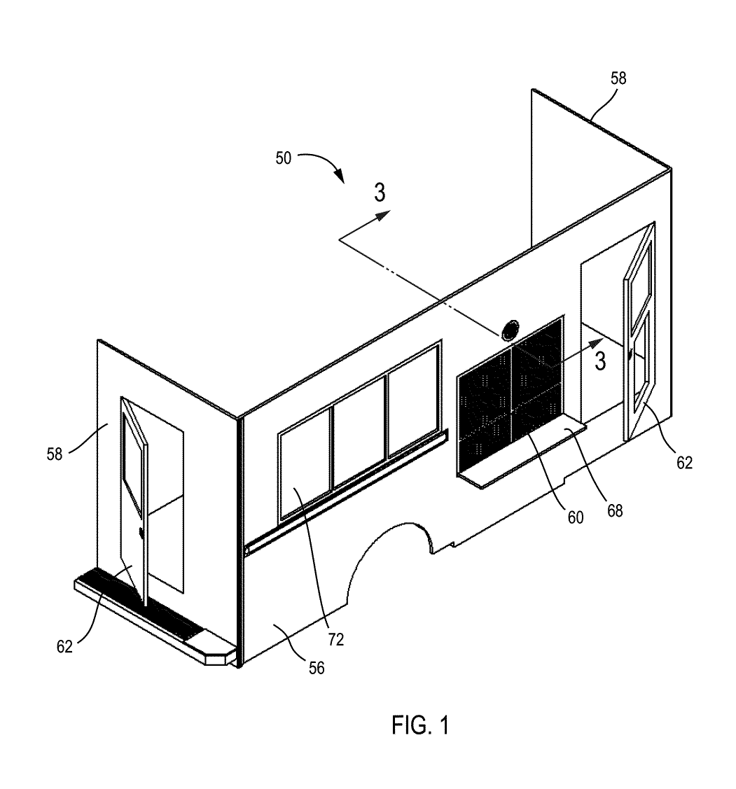

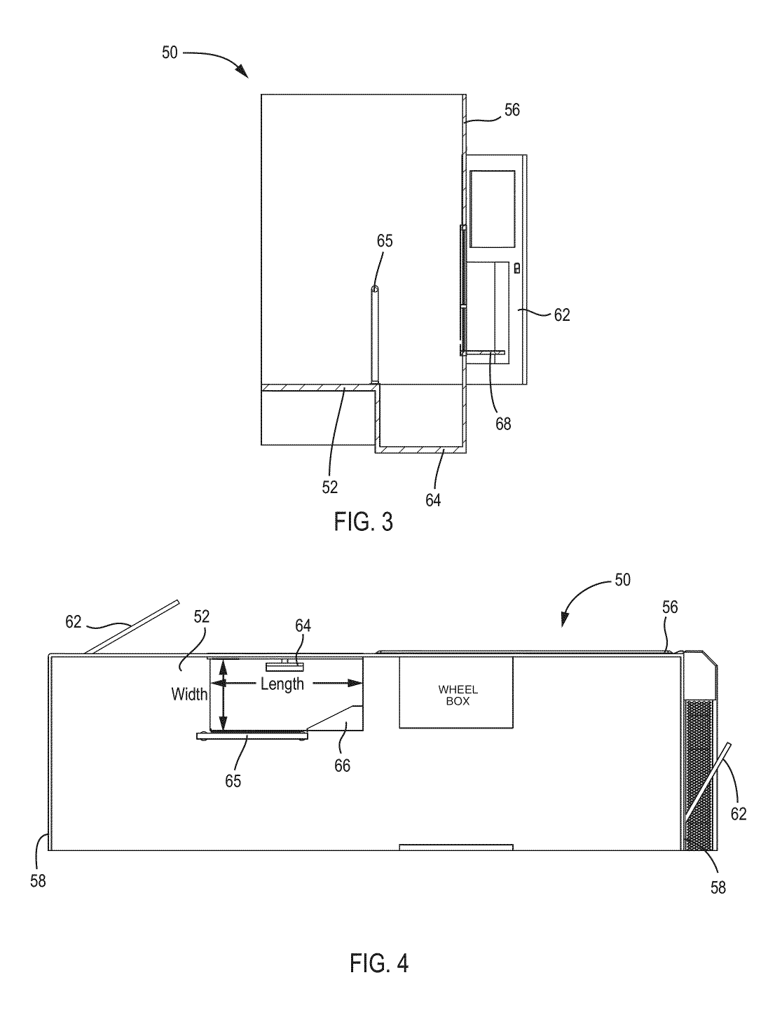

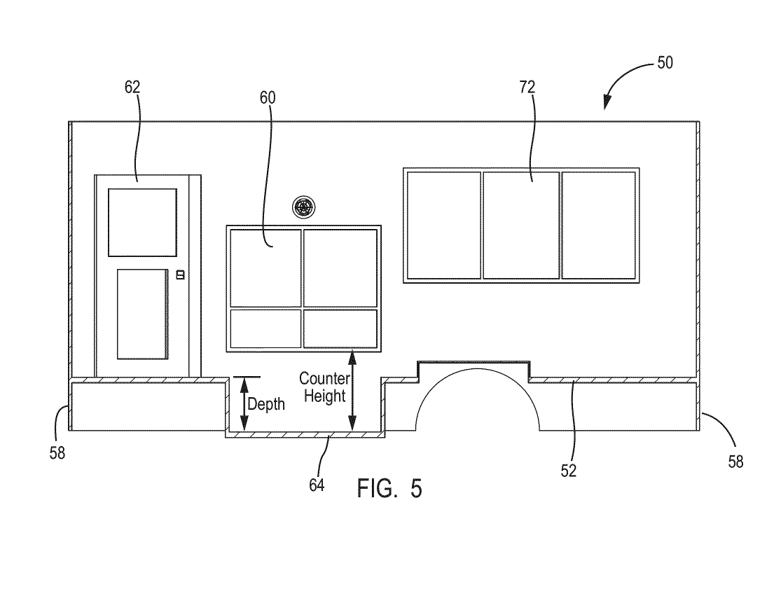

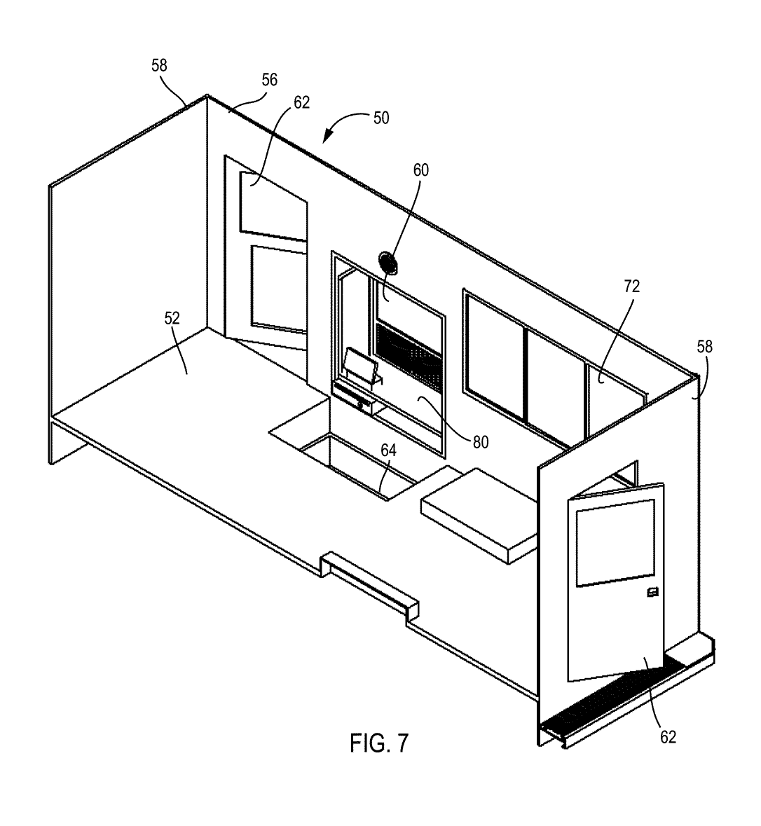

Referring in general to FIGS. 1-10, an enclosure 50 for a vehicle/trailer is shown according to an exemplary embodiment. The enclosure 50 is formed by a floor 52, a roof (not shown), a driver side wall (not shown), a passenger side wall 56 and two end walls 58. The enclosure 50 may be coupled to a frame (not shown), which may include a pair of longitudinal frame rails extending below the floor 52 of the enclosure 50. The enclosure 50 is configured to house a vendor or other occupant that interacts with a person outside of the enclosure through an opening 60 (e.g., the transaction window) in the enclosure 50. The interior of the enclosure 50 may be accessed through one or more doors 62. The enclosure 50 may be configured for a concession vendor, a souvenir vendor, an information kiosk, etc.

The floor 52 has a height off the ground that is generally determined by the height of the frame rails. The floor 52 includes a lowered portion 64 proximate to the opening 60 that allows an occupant inside the enclosure to be at a level closer to the level of a person outside of the vehicle. For example, the occupant inside the enclosure 50 may be a clerk or cashier interacting with a customer through the opening 60. The lowered portion 64 can improve the interaction between clerk and customer by improving ergonomics of goods transfer between clerk and customer (e.g., reduced bending for clerk, reduced reaching up to a high counter for customer, etc.). Further, the lowered portion 64 can improve safety for customer (e.g., by allowing hot items to be delivered at a lower, more natural height to the customer).

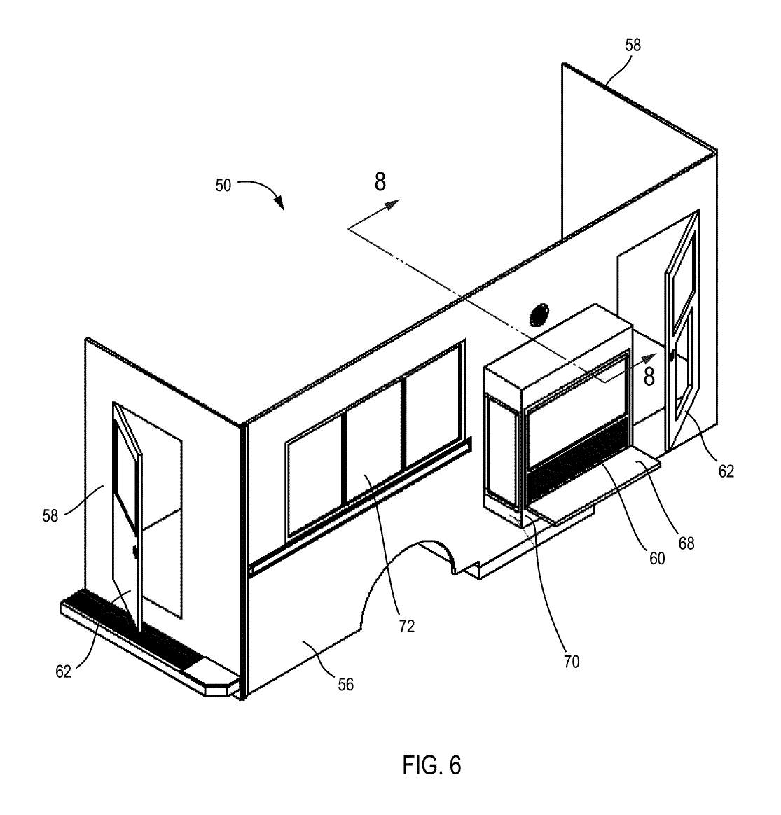

The lowered portion 64 may be stationary or may be mechanically lowered. According to an exemplary embodiment, the lowered portion 64 may be fixed at a floor-to-ground height of 6-20 inches, or 12-20 inches, or preferably, 12-14 inches, to maintain sufficient ground clearance for normal driving of the vehicle (see, e.g., FIGS. 1-5). According to another exemplary embodiment, if the lowered portion 64 is configured to be mechanically lowered, the lowered portion 64 may be lowered completely to ground level or may be lowered to a desired height above the ground (see FIGS. 6-10). For example, the lowered portion may be configured to be mechanically lowered from a first position between, for example, 20-42 inches, or 30-42 inches from the ground, to a second position between, for example, 0-20 inches, or 12-20 inches, or 12-14, or 0-6 inches from the ground.

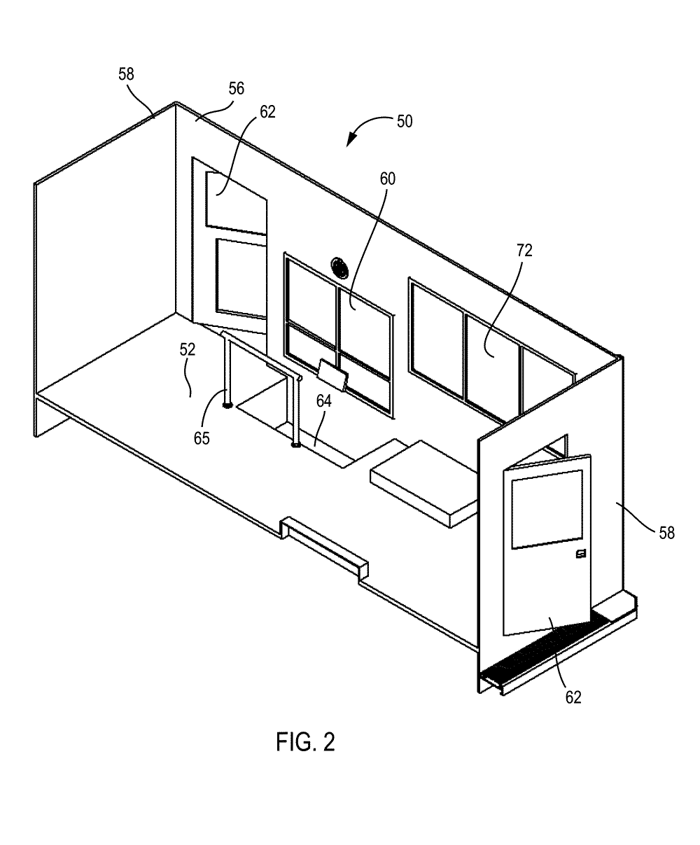

Referring to FIGS. 1-5, the enclosure 50 is shown according to one exemplary embodiment to include a floor 52 with a lowered portion 64 on the passenger side, outboard of the frame rail. As shown in FIGS. 2-4, a railing 65 may be provided around at least a portion of the lowered portion 64 to reduce the likelihood that an occupant of the enclosure 50 will inadvertently step into the lowered portion 64. Further, a step 66 may be provided at a height intermediate between the heights of the floor 52 and the lowered portion 64. The opening 60 may include a screen, window, or other covering to limit egress into the enclosure 50.

A shelf 68 may extend below the opening 60 to provide a surface to facilitate a transaction between an occupant inside of the enclosure 50 and a person outside the enclosure 50. The shelf 68 may be configured to fold from a generally horizontal position to a generally vertical position for transport or storage.

The enclosure 50 may include a second opening 72 proximate to another area, such as a food preparation area. The second opening 72 may be higher than the opening 60 proximate to the lowered portion 64 and may not be configured for transactions but instead may be configured to provide ventilation, light, or visibility to occupants inside the enclosure 50.

Referring now to FIGS. 6-10, in another exemplary embodiment, a portion of the wall 56 in which the opening 60 is provided may be configured to be movable (e.g., expandable, slidable, etc.). The moveable section 80 may telescope outward relative to the rest of the wall 56. The bottom wall or floor of the moveable section 80 may be utilized as a shelf for transaction equipment (e.g., cash registers, point of sale hardware, etc.). The moveable section 80 may be supported by the wall 56 or may include one or more supports or legs to provide additional support for the weight of the moveable section 80 and any objects resting on the movable section 80. The moveable section 80 may be moved through a variety of mechanisms, including hydraulic or pneumatic actuators, electric motors, or via a manual device (e.g., a manual lever or crank).

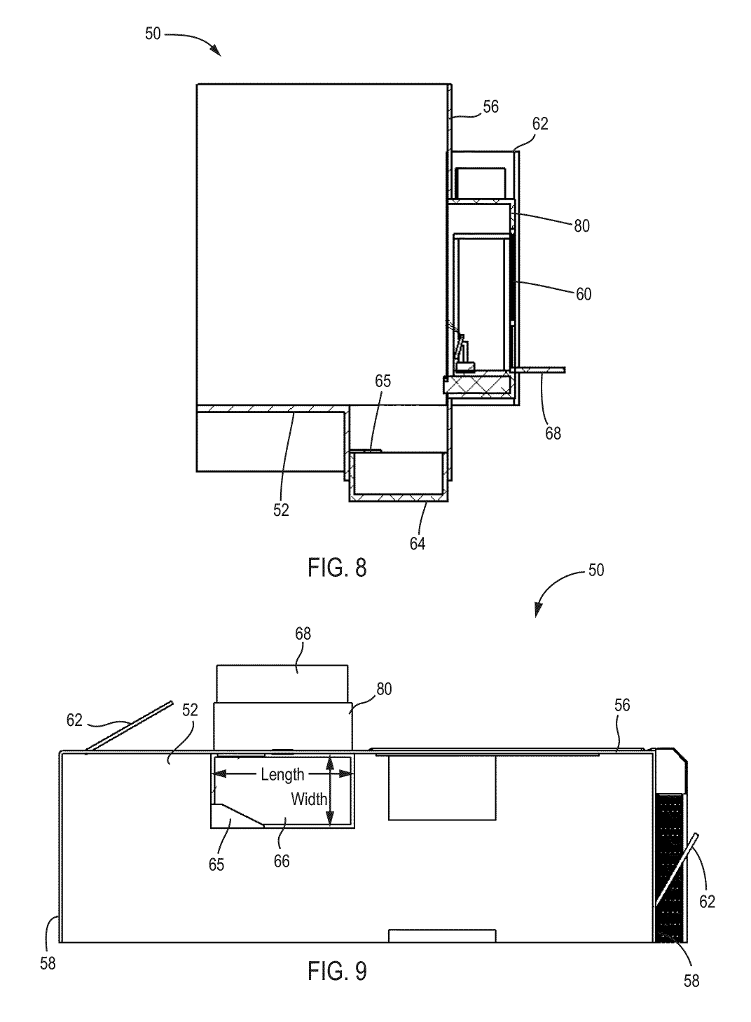

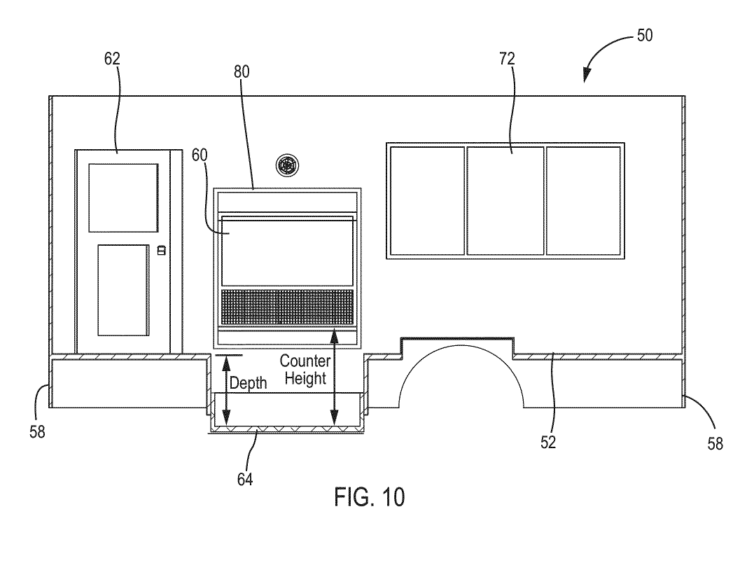

The lowered portion 64 of the floor 52, in the embodiment shown in FIGS. 6-10, is configured to be mechanically lowered from a first position (e.g., raised position, storage position, transport position, etc.) to a second position (e.g., lowered position, operational position, etc.). The lowered portion 64 may be lowered through a variety of mechanisms, including hydraulic or pneumatic actuators, electric motors, or via a manual device (e.g., a manual lever or crank). As shown in FIGS. 8 and 10, the lowered portion 64 may be lowered to a reduced height over the ground relative to the rest of the floor 52. In other embodiments, the lowered portion 64 may be lowered until it rests directly on the ground.

The enclosure 50 may be rigidly coupled to a vehicle frame, such as a truck frame. In other exemplary embodiments, the enclosure 50 may be configured as a trailer on a separate frame and may be coupled to a truck via an appropriate mechanism such as a fifth wheel coupling. The truck may transport the enclosure 50 to a location and the enclosure 50 may be then decoupled from the truck and remain at the location as a free-standing structure.

The construction and arrangement of the elements of the retail vehicle/trailer as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. Some like components have been described in the present disclosure using the same reference numerals in different figures. This should not be construed as an implication that these components are identical in all embodiments; various modifications may be made in various different embodiments. It should be noted that the elements and/or assemblies of the enclosure may be constructed from any of a wide variety of materials that provide sufficient strength or durability, in any of a wide variety of colors, textures, and combinations.

What is claimed is:

1. An enclosure for a vehicle, the enclosure comprising:
a wall that includes an opening therein,
a floor, and
a lowered portion that is recessed into the floor in an area of the floor proximate the opening in the wall.

2. The enclosure of claim 1, wherein the lowered portion is permanently recessed into the floor.

3. The enclosure of claim 2, wherein the lowered portion is configured to be at a height of 6-20 inches above ground.

4. The enclosure of claim 1, wherein the lowered portion is configured to be lowered from a first position to a second position lower than the first position.

5. The enclosure of claim 4, wherein the lowered portion is mechanically lowered from the first position to the second position by a mechanism comprising a hydraulic actuator, a pneumatic actuator, an electric motor, or a manual device.

6. The enclosure of claim 4, wherein the first position is configured to be 20-42 inches above ground and the second position is configured to be 20 inches or less above ground.

7. The enclosure of claim 4, wherein in the second position, the lower portion is configured to contact ground.

8. The enclosure of claim 1, further comprising a railing provided around at least a portion of a perimeter of the lowered portion.

9. The enclosure of claim 1, further comprising a step provided at a height between a height of the floor and a height of the lowered portion.

10. The enclosure of claim 1, wherein the wall including the opening therein is a passenger side wall.

11. The enclosure of claim 1, further comprising a shelf extending below the opening, the shelf foldable between a first shelf position that is horizontal and perpendicular to the wall and a second shelf position that is vertical and parallel to the wall.

12. The enclosure of claim 1, further comprising a moveable section of the wall configured to move outward relative to the wall.

13. The enclosure of claim 12, wherein the moveable section is moved by a mechanism comprising a hydraulic actuator, a pneumatic actuator, an electric motor, or a manual device.

14. The enclosure of claim 12, wherein a weight of the moveable section and any object resting thereon is configured to be supported by the wall.

15. The enclosure of claim 14, further comprising one or more support legs attached to the moveable section and configured to additionally support the weight of the moveable section and any object resting thereon.

16. The enclosure of claim 12, wherein the moveable section comprises a portion configured to be used as a shelf capable of supporting objects.

17. The enclosure of claim 1, further comprising a second opening, independent of the opening of the wall proximate to the lowered portion, the second opening configured to be disposed at a height above a height of the opening of the wall.

18. The enclosure of claim 1, wherein the enclosure is configured to decouple from the vehicle and remain at a location as a free-standing structure.

19. A vehicle comprising the enclosure of claim 1, wherein the enclosure is rigidly coupled to a frame of the vehicle.

20. A trailer comprising the enclosure of claim 1, wherein the enclosure is coupled to a frame of the trailer, and the frame of the trailer is coupled to a vehicle via a coupling mechanism.
